(19) United States
(12) Patent Application Publication
(10) Pub. No.: US 2002/0096402 A1
(43) Pub. Date: Jul. 25, 2002

(54) Dual wheel locking chock

(75) Inventors: Andy Tallman, Manhattan Beach, CA (US); Robert Fox, Wilmington, CA (US); Michael H. Minns, Akron, OH (US)

Correspondence Address: HAHN LOESER & PARKS, LLP, TWIN OAKS ESTATE, 1225 W. MARKET STREET, AKRON, OH, 44313, US

(73) Assignee: Norco Industries, Inc.

(21) Appl. No.: 10/114,622

(22) Filed: Apr. 2, 2002

Related U.S. Application Data
(63) Continuation-in-part of application No. 09/395,783, filed on Sep. 14, 1999.

(51) Int. Cl. B60T 1/00; B60T 3/00

(52) U.S. Cl. 188/4 R; 188/32

(57) ABSTRACT

Embodiments of a locking wheel chock apparatus are disclosed for use with recreational vehicles, travel trailers and boat trailers having dual axles. The chock apparatus functions not only to hold a trailer in position, but also to limit the rocking or rotational movement of tire and wheel combination where a recreational vehicle or travel trailer is used for camping, i.e. living conditions. The chock apparatus generally comprises a pair of metal chocks, which are movably linked together by a screw driven mechanism for tightening and loosening the chocks about the tread area of adjacent tires. The chock assembly is capable of being reduced to a small package to facilitate storage and transportation when not in use.

This application is a continuation-in-part of co-pending application Ser. No. 09/395,783, filed Sep. 14, 1999, the disclosure of which is hereby incorporated by reference.

### BACKGROUND OF THE INVENTION

This invention relates generally to a wheel chock apparatus, and more particularly to a locking chock apparatus that is especially suited for use between the tires of dual axle vehicles such as travel trailers, boat trailers and the like.

When vehicles with tandem axle wheels are to be parked at a selected location and expected to remain immovably in fixed position until the occasion arises when they are again expected to be mobile, some type of braking mechanism is needed. Such need becomes particularly acute when the surface on which the vehicle is parked is other than level. Under circumstances where the vehicle is a trailer type vehicle, not supplied with a conventional braking arrangement, some form of blocking device for the wheels becomes necessary, whether the vehicle has single axle wheels or tandem axle wheels.

Recreational vehicle wheels also have a tendency to rotate when people move around inside the recreational vehicle, even when auxiliary jacks and a vehicle tongue jack have been used to level and stabilize the recreational vehicle.

In recognition of this need, the industry has heretofore provided tandem locking chocks of some description which, once in position between the wheels of the tandem axles, can be pushed against each other by some appropriate mechanism into positions where one chock is pushed to blocking position against a forward wheel and the other chock simultaneously pushed into blocking position against the aft wheel. Chocking devices of this general character and of varying degrees of mechanical capability have heretofore been available. Practical problems represented, for example, by variable spacing in a fore and aft direction with respect to the tandem axles still need to be met.

The foregoing illustrates limitations known to exist in present dual wheel locking chocks. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the present invention, this is accomplished by providing a dual wheel locking chock for use with adjacently positioned dual tires comprising: a pair of vertically spaced apart chocks, each chock being adapted to engage both tires; a threaded operator movably connecting the chocks; and a laterally extending tab connecting a chock to the threaded operator, each chock being laterally offset from a longitudinal axis extending through the threaded operator.

In another aspect of the present invention, this is accomplished by providing a dual wheel locking chock for use with adjacently positioned dual tires comprising: a pair of vertically spaced apart chocks, each chock having two spaced apart tire engaging surfaces, one tire engaging surface adapted to engage a first one of the dual tires, the other tire engaging surface adapted to engage a second one of the dual tires; and a means for vertically tightening and loosening the chocks against the tires, the means for vertically tightening and loosening being laterally spaced from the chocks and the dual tires, the means for vertically tightening and loosening not being positioned between the tires.

In another aspect of the present invention, this is accomplished by providing a wheel locking chock for use with at least one tire comprising: a pair of spaced apart chocks; and a means for tightening and loosening the chocks against the at least one tire, the means for tightening and loosening being laterally spaced from the chocks and the at least one tire. This embodiment can be used as a single wheel locking chock or a dual wheel locking chock.

The foregoing and other aspects will become apparent from the following detailed description of the invention when considered in conjunction with the accompanying drawing figures.

### BRIEF DESCRIPTION OF THE DRAWING FIGURES

FIG. 1 is a perspective view of a dual wheel locking chock according to one embodiment of the present invention;

FIG. 1A is a perspective view of an alternate embodiment of the dual wheel locking chock shown in FIG. 1;

FIG. 2 is a second perspective view of the dual wheel locking chock shown in FIG. 1;

FIG. 3 is a front view of the dual wheel locking chock shown in FIG. 1, shown in use with dual wheels;

FIG. 4 is a side view of the dual wheel locking chock shown in FIG. 3, with a portion of the tire removed;

FIG. 5 is a perspective view of the dual wheel locking chock shown in FIG. 3;

FIG. 6 is an enlarged perspective view of the upper portion of the dual wheel locking chock shown in FIG. 1, with a portion of the upper chock removed;

FIG. 7 is a top view of a second embodiment of a dual wheel locking chock of the present invention; and

FIG. 8 is a perspective view of the dual wheel locking chock shown in FIG. 7.

### DETAILED DESCRIPTION

A dual wheel locking chock 210 is shown in the FIGURES. The dual wheel locking chock 210 has two vertically spaced chocks 215 that fit between two adjacently spaced tires 272 of a dual axle trailer or recreational vehicle. A threaded operator is used to tighten the chocks 215 against the tires 272 by moving the chocks 215 towards one another.

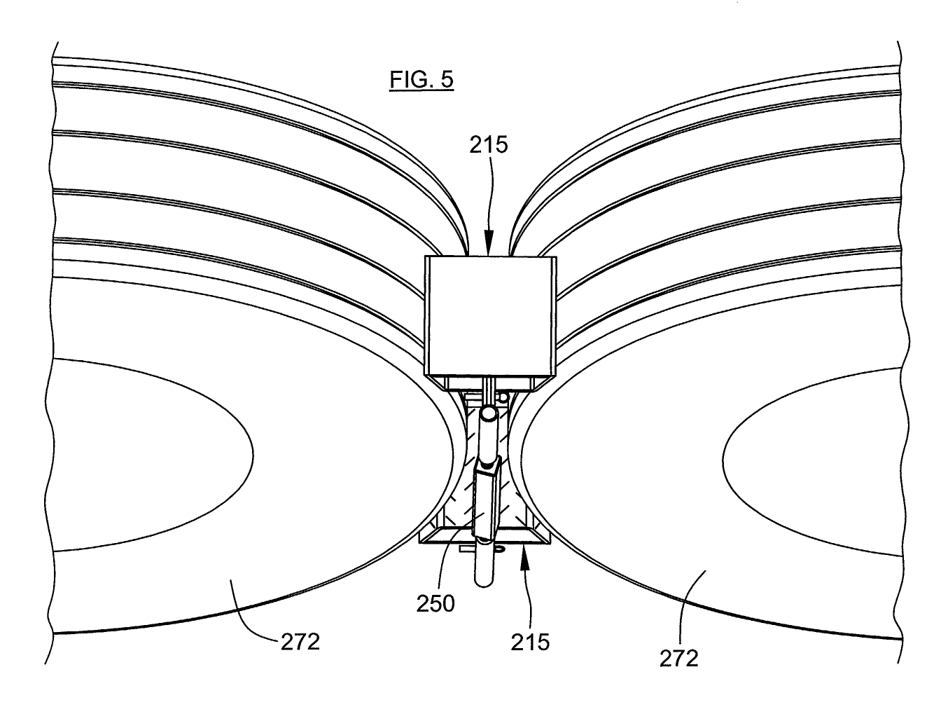

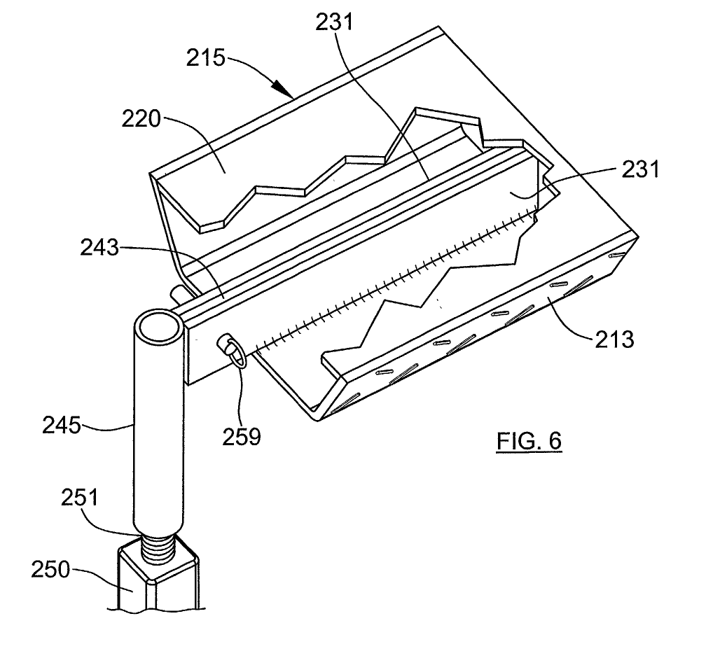

Each chock 215 has two spaced apart tire engaging surfaces 213 that bear against an adjacent tire 272. Each tire engaging surface 213 may have a non-slip checker pattern, as shown in the FIGURES. Preferably, each tire engaging surface 213 is inclined towards the adjacent tire 272. Other shapes, such as a curved surface that matches or approximates the curvature of the tire 272 may be used. Chock 215 may have an open trapezoidal shape formed by four sides (first surface 220, second surface 219 and tire engaging surfaces 213). Preferably, chock 215 is removably attached to the threaded operator. A vertical mid-support plate 231 is positioned midway between tire engaging surfaces 213 and is welded to both first surface 220 and second surface 219. The mid-support 231 extends outside of chock 215, as shown in FIGS. 5 and 6. Preferably, mid-support 231 consists of two parallel spaced apart plates. A laterally extending tab 243 extends from a threaded connector 245 (and parallel to mid-support 231), which is part of the threaded operator. The chock 215 is connected to the threaded connector 245 by inserting tab 243 into chock 215 between mid-support plates 231, and placing detent pin 259 through apertures (not shown) in both mid-support 231 and tab 243. Chock 215 may be also non-removably attached to the threaded operator by welding tab 243 to chock 215.

A threaded operator is used to vertically tighten and loosen the chocks 215. the threaded operator consists of a hand grip 250 having left hand threaded and right hand threaded rods 251 welded to hand grip 250. Preferably hand grip 250 has a longitudinally extending polygonal shape, which can be turned by hand or by a wrench (not shown). Each threaded rod 251 extends into a tubular threaded connector 245, one having right hand threads and one having left hand threads. The laterally extending tabs 243 extend from the threaded connectors 245. Therefore, chocks 215 are laterally offset from a longitudinal axis extending through the threaded operator (250, 251, 245). The laterally extending tab 243 allows the threaded operator to be positioned outside of tires 272, as shown in FIGS. 4 and 5. This allows the dual wheel locking chock 210 to be used with tire spacing that is too narrow to allow the chock operator to fit between the tires. As shown in FIG. 5, if the threaded operator, including hand grip 250, were positioned between tires 272, it would not be possible to turn hand grip 250. There is insufficient clearance between tires 272 to fit one's hand around hand grip 250. Some dual axle recreational vehicles have tire spacings as small as one inch.

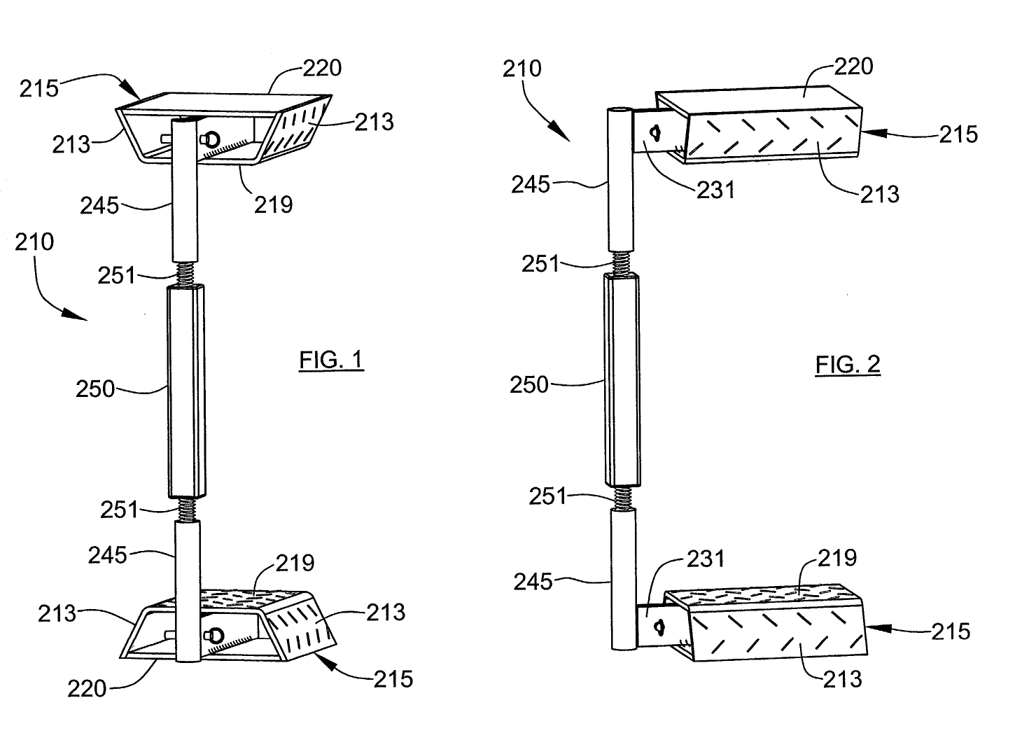

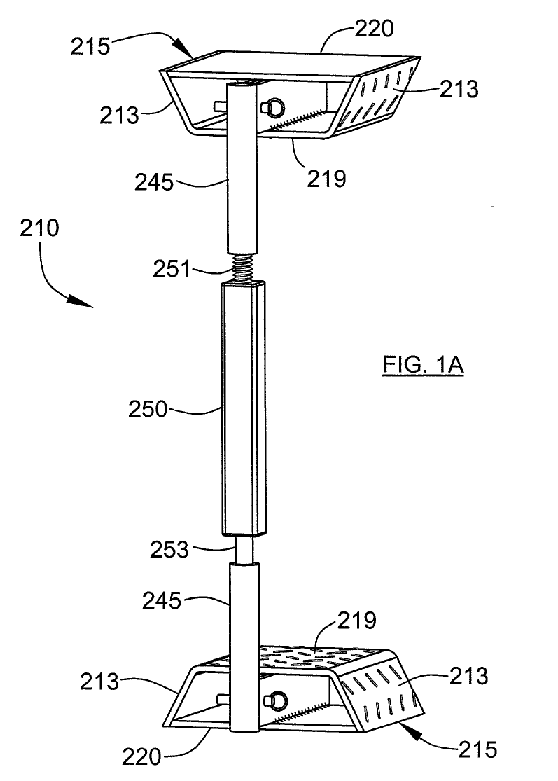

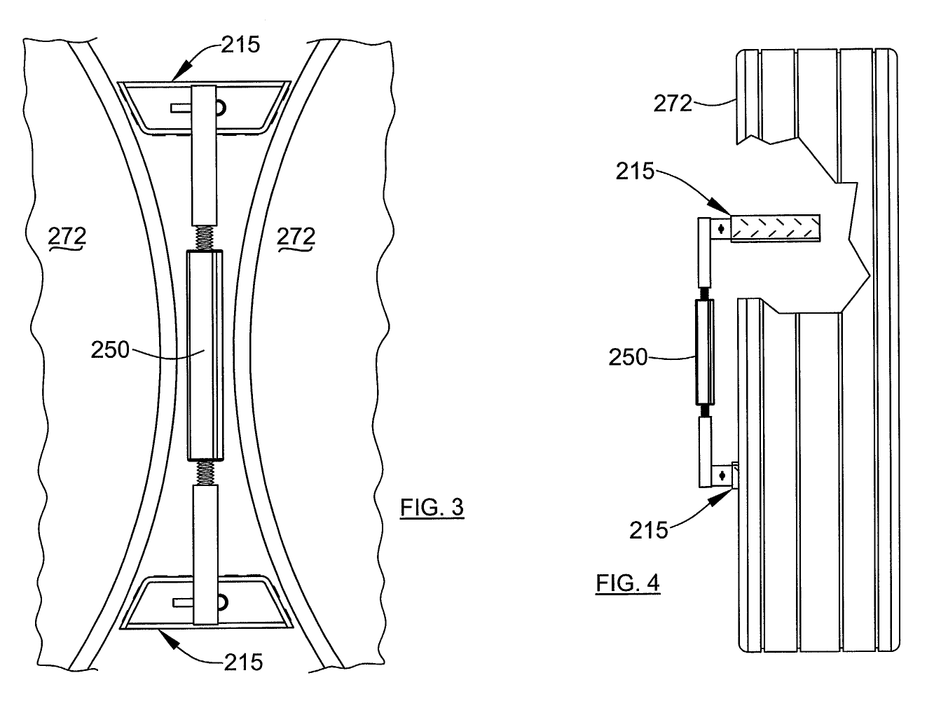

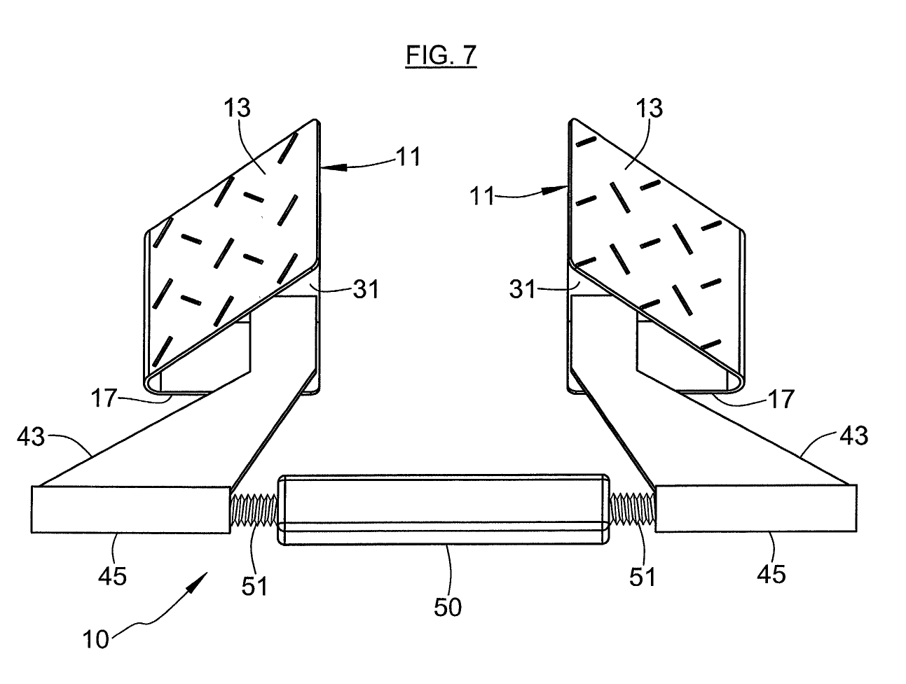

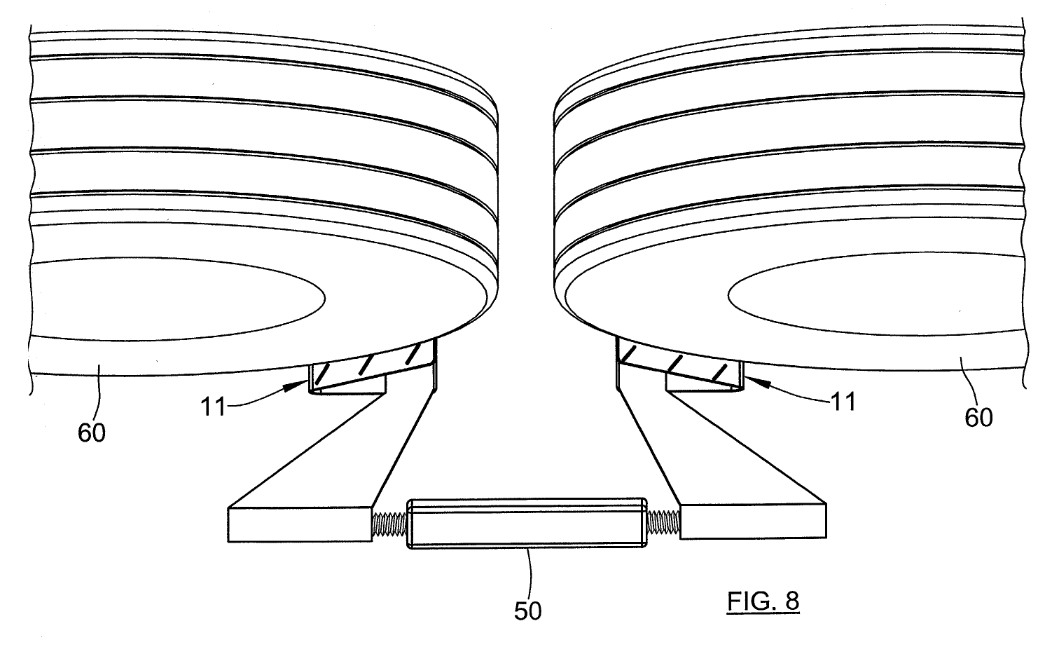

FIG. 1A shows a variation of the dual wheel locking chock 210 shown in FIG. 1. In this variation, only one threaded rod 251 is welded to hand grip 250. At the other end of hand grip 250, an unthreaded rod 253 is welded to hand grip 250. Unthreaded rod 253 is then rotatably attached to connector 245, which may also be unthreaded. This variation can also be applied to the dual wheel locking chock 10 shown in FIGS. 7 and 8.

FIGS. 7 and 8 show an alternate embodiment of dual wheel locking chock. Dual wheel locking chock 10 is similar to the single wheel locking chock described in co-pending U.S. patent application Ser. No. 09/395,783, which is incorporated by reference. Dual wheel locking chock 10 has two spaced chocks 11 that fit between two adjacently spaced tires 60 of a dual axle trailer or recreational vehicle. A threaded operator is used to tighten the chocks 11 against the tires 60 by moving the chocks 11 away from one another.

Each chock 11 has an inclined tire engaging surface 13 that bears against a tire 60. Other shapes, such as a curved surface that matches or approximates the curvature of tire 60 may be used. Chocks 11 face away from each other towards tires 60. Each tire engaging surface 13 may have a non-slip checker pattern, as shown in FIGS. 7 and 8. Chock 11 has a wedge shaped formed by tire engaging surface 13 and base 17. A vertical wedge shaped reinforcing web 31 extends between base 17 and tire engaging surface 13 and is preferably welded to both base 17 and tire engaging surface 13. A laterally extending tab 43 extends from a threaded connector 45 and is welded to reinforcing web 31.

A threaded operator is used to tighten and loosen the chocks 11. The threaded operator consists of a hand grip 50 having left hand threaded and right hand threaded rods 51 welded to hand grip 50. Preferably hand grip 50 has a longitudinally extending polygonal shaped, which can be turned by hand or by a wrench (not shown). Each threaded rod 51 extends into a tubular threaded connector 45, one having right hand threads and one having left hand threads. The laterally extending tabs 43 extend from a longitudinal axis extending through the threaded operator (50, 51, 45). The laterally extending tab 43 allows the threaded operator to be positioned outside of tires 60, as shown in FIG. 8. This allows the dual wheel locking chock 10 to be used with tire spacing that is too narrow to allow the chock operator to fit between the tires.

Reversing the attachment of chocks 11 and the laterally extending tabs 43, such that the chocks 11 face each other and tabs 43 extend away from hand grip 50 would form a locking wheel chock that could be used with a single tire, similar to the locking chock described in U.S. patent application Ser. No. 09/395,783.

Having described the invention, what is claimed is:

1. A dual wheel locking chock for use with adjacently positioned dual tires comprising:
a pair of vertically spaced apart chocks, each chock having two spaced apart tire engaging surfaces, one tire engaging surface adapted to engage a first one of the dual tires, the other tire engaging surface adapted to engage a second one of the dual tires; and
a means for vertically tightening and loosening the chocks against the tires, the means for vertically tightening and loosening being laterally spaced from the chocks and the dual tires, the means for vertically tightening and loosening not being positioned between the tires.

2. The dual wheel locking chock according to claim 1, wherein each chock is removably attached to the means for vertically tightening and loosening.

3. The dual wheel locking chock according to claim 1, further comprising:
a laterally extending tab connecting a chock to the means for vertically tightening and loosening, each chock being laterally offset from a longitudinal axis extending through the means for vertically tightening and loosening.

4. The dual wheel locking chock according to claim 1, wherein the means for vertically tightening and loosening comprises: a threaded assembly positioned between the pair of chocks and movably connecting the pair of chocks, the threaded assembly including: an elongated rotatable polygonal hand grip; a right hand threaded rod attached to one end of the hand grip; a left hand threaded rod attached to the other end of the hand grip; the right hand threaded rod threadedly engaging a first threaded connector, and the left hand threaded rod threadedly engaging a second threaded connector, each chock being connected to one of the threaded connectors.

5. The dual wheel locking chock according to claim 4, wherein there is one and only one threaded assembly.

6. A dual wheel locking chock for use with adjacently positioned dual tires comprising:
a pair of vertically spaced apart chocks, each chock having two spaced apart tire engaging surfaces, one tire engaging surface adapted to engage a first one of the dual tires, the other tire engaging surface adapted to engage a second one of the dual tires; and
a single threaded assembly positioned between the pair of chocks and movably connecting the pair of chocks, the threaded assembly comprising: an elongated rotatable polygonal hand grip; a rod being attached to each end of the hand grip, each rod engaging a connector, each connector being connected to a chock, at least one rod being threaded, at least one connector being threaded, a threaded rod threadedly engaging a threaded connector.

7. The dual wheel locking chock according to claim 6, wherein one rod and one connector are threaded, the other rod rotatably engages the other connector.

8. The dual wheel locking chock according to claim 6, wherein both rods and both connectors are threaded, one rod has a right hand thread, the other rod has a left hand thread.

9. The dual wheel locking chock according to claim 6, further comprising:
a laterally extending tab connecting a chock to a connector, each chock being laterally offset from a longitudinal axis extending through the threaded assembly.

10. The dual wheel locking chock according to claim 6, wherein each chock is removably connected to a connector.

11. The dual wheel locking chock according to claim 6, wherein each chock has a first surface, and a second surface spaced from the first surface, each tire engaging surface connecting the first surface and the second surface.

12. The dual wheel locking chock according to claim 11, wherein each chock has a mid-support connected to the first surface and the second surface, the support being positioned between the tire engaging surfaces.

13. The dual wheel locking chock according to claim 12, further comprising:
a laterally extending tab connecting a chock to a connector, each chock being laterally offset from a longitudinal axis extending through the threaded assembly, the laterally extending tab being connected to the mid-support.

14. The dual wheel locking chock according to claim 13, wherein the laterally extending tab is removably connected to the mid-support.

15. The dual wheel locking chock according to claim 14, wherein a portion of the laterally extending tab overlaps at least a portion of the mid-support.

16. The dual wheel locking chock according to claim 13, wherein the laterally extending tab and the mid-support are integral with one another.

17. The dual wheel locking chock according to claim 6, wherein each tire engaging surface is inclined towards an adjacent tire.

18. A dual wheel locking chock for use with adjacently positioned dual tires comprising:
a pair of vertically spaced apart chocks, each chock being adapted to engage both tires;
a threaded operator movably connecting the chocks; and
a laterally extending tab connecting a chock to the threaded operator, each chock being laterally offset from a longitudinal axis extending through the threaded operator.

19. The dual wheel locking chock according to claim 18, wherein the threaded operator is threadedly connected to one chock and is rotatably connected to the other chock.

20. The dual wheel locking chock according to claim 18, wherein the threaded operator is threadedly connected to both chocks.

21. The dual wheel locking chock according to claim 18, wherein each chock is removably connected to the threaded operator.

22. The dual wheel locking chock according to claim 18, wherein each chock has two spaced apart tire engaging surfaces.

23. The dual wheel locking chock according to claim 22, wherein each tire engaging surface is inclined towards an adjacent tire.

24. The dual wheel locking chock according to claim 18, wherein there is one and only one threaded operator.

25. A dual wheel locking chock for use with adjacently positioned dual tires comprising:
a pair of vertically spaced apart chocks, each chock being adapted to engage both tires;
a single threaded operator movably connecting the chocks, the chocks be removably connected to the threaded operator; and
a laterally extending tab connecting a chock to the threaded operator, each chock being laterally offset from a longitudinal axis extending through the threaded operator.

26. A wheel locking chock for use with at least one tire comprising:
a pair of spaced apart chocks; and
a means for tightening and loosening the chocks against the at least one tire, the means for tightening and loosening being laterally spaced from the chocks and the at least one tire.

27. The wheel locking chock according to claim 26, further comprising:
a laterally extending tab connecting a chock to the means for tightening and loosening, each chock being laterally offset from a longitudinal axis extending through the means for tightening and loosening.

28. The wheel locking chock according to claim 26, wherein the means for tightening and loosening comprises: a threaded assembly positioned between the pair of chocks and movably connecting the pair of chocks, the threaded assembly including: an elongated rotatable polygonal hand grip; a rod being attached to each end of the hand grip, each rod engaging a connector, each connector being connected to a chock, at least one rod being threaded, at least one connector being threaded, a threaded rod threadedly engaging a threaded connector.

29. The wheel locking chock according to claim 28, wherein one rod and one connector are threaded, the other rod rotatably engages the other connector.

30. The wheel locking chock according to claim 28, wherein both rods and both connectors are threaded, one rod has a right hand thread, the other rod has a left hand thread.

31. The wheel locking chock according to claim 28, wherein there is one and only one threaded assembly.

32. The wheel locking chock according to claim 26, wherein the number of tires is one and the chocks fit against a single tire.

33. The wheel locking chock according to claim 26, wherein the number of tires is two and one chock fits against one tire, the other chock fits against the other tire.

34. The wheel locking chock according to claim 26, wherein the number of tires is two, each chock having two spaced apart tire engaging surfaces, one tire engaging surface adapted to engage a first one of the two tires, the other tire engaging surface adapted to engage a second one of the two tires, the means for tightening and loosening not being positioned between the tires.

35. A wheel locking chock for use with at least one tire comprising:
a pair of spaced apart chocks; and
a single threaded assembly positioned between the pair of chocks and movably connecting the pair of chocks, the threaded assembly comprising: an elongated rotatable polygonal hand grip; a rod being attached to each end of the hand grip, each rod engaging a connector, each chock being connected to one of the connectors, at least one rod being threaded, at least one connector being threaded, a threaded rod threadedly engaging a threaded connector, an unthreaded rod rotatably engaging an unthreaded connector.

36. A dual wheel locking chock for use with adjacently positioned dual tires comprising:
a pair of spaced apart chocks, each chock having a tire engaging surface adapted to engage one of the dual tires; and
a single threaded assembly positioned between the pair of chocks and movably connecting the pair of chocks, the threaded assembly comprising: an elongated rotatable polygonal hand grip; a rod being attached to each end of the hand grip, each rod engaging a connector, each chock being connected to one of the connectors, at least one rod being threaded, at least one connector being threaded, a threaded rod threadedly engaging a threaded connector, an unthreaded rod rotatably engaging an unthreaded connector.
